(19) United States
(12) Patent Application Publication
(10) Pub. No.: US 2012/0170564 A1
(43) Pub. Date: Jul. 5, 2012

(54) FRAME FORMATION METHOD HAVING IMPROVED COMMUNICATION EFFICIENCY IN WIRELESS COMMUNICATION NETWORK FOR IN-BODY MEDICAL DEVICE

(75) Inventors: Young Hwan Kim, Yongin-si (KR); Jae Gi Son, Seongnam-si (KR); Ha Joong Chung, Anyang-si (KR); Chang Won Park, Suwon-si (KR)

(73) Assignee: KOREA ELECTRONICS TECHNOLOGY INSTITUTE, Seongnam-si, Gyeonggi-do (KR)

(21) Appl. No.: 13/386,617

(22) PCT Filed: Mar. 4, 2010
(86) PCT No.: PCT/KR2010/001362

§ 371 Date: Mar. 19, 2012

(30) Foreign Application Priority Data
Jul. 22, 2009 (KR) 10-2009-0066790

(51) Int. Cl. H04W 56/00; H04W 12/00

(52) U.S. Cl. 370/338

(57) ABSTRACT

Disclosed herein is a method of forming communication frames. The communication frames each include a PHY header, a MAC header and a payload. The method includes forming the PHY header so that the PHY header includes information configured to support synchronization with a reception unit and information indicative of the start and overall size of the frame; forming the MAC header so that the MAC header includes information indicative of the type of frame, information configured to be used to check for the sequence of the frame and perform flow control, flag information, information indicative of the size of the data block, source and destination information, and information configured to be used to check the header of the frame for an error and correct the error; and forming the payload so that each of a plurality of data blocks includes information configured to perform error check and correction.

### BACKGROUND OF THE INVENTION

1. Field of the Invention

The present invention relates generally to a method of forming communication frames and, more particularly, to a method of forming communication frames capable of supporting a security selection function, which are used on a wireless communication network for implantable medical devices.

2. Description of the Related Art

A Wireless Body Area Network (WEAN) which is a communication network which is used for the wireless communication technology dedicated to medical use may be defined as a communication network which is used in the in-body medical field in which a device implanted in the human body is monitored from outside the human body or the on/out-body medical field in which an event occurs on the surface of the human body or in an area 3˜5 meters away from the human body.

FIG. 1 is a diagram showing an example of a conventional Medical Implant Communications System (MICS). The MICS provides two-way communication between the transmitters and receivers of an external device 50 and implantable medical devices 10, 20, 30 and 40 disposed in the human body. The implantable devices include, for example, an implantable cardioverter defibrillator 10, a pacemaker 20, a drug delivery 30, and a deep brain stimulator 40. Such implantable medical devices measure the bio-signals of humans and wirelessly exchange data with the coordinator 50, that is, the external device, and the coordinator 50 communicates with a management apparatus 60 which performs clinic follow-up, central monitoring, emergency call, management, etc. in compliance with a program system, thereby performing a variety of types of treatments, such as the control of the cardiac impulses of a human, the control of pain, the administration of medicine, the control of urinary incontinence, and the control of insulin for diabetes. In this case, a communication network that is used between the implantable medical devices 10, 20, 30 and 40 and the coordinator 50 is a WBAN. Meanwhile, since the human body is made up of a variety of components such as water, fibroid material and bones, the attenuation of radio waves and the loss of power in the human body are higher, in proportion to the depth in the human body, than those in the air. This exerts a bad influence on the life spans of the batteries of the implantable medical devices. Accordingly, research has been conducted into a variety of schemes for reducing the loss of power during communication on the WBAN. One of them relates to the structure of a communication frame.

FIG. 2 is a diagram showing an example of the structure of a conventional communication frame. The structure of the conventional communication frame includes a PHY header, a MAC header, and a payload. The PHY header includes a Preamble Sequence (PS) information field configured to support synchronization with a reception unit, a Start of Frame Delimiter (SFD) information field indicative of the start of the frame, and a Frame Length (FL) information field indicative of the overall size of the frame. The MAC header includes a Frame Type (FT) information field indicative of the type of frame, a Sequence Number (SN) information field configured to be used to check for the sequence of the frame, and a source and destination (S&D) information field configured to be used to support the connection between a source and a destination. The payload includes payload information, that is, information about data to be transmitted, and Frame Check Sequence (FCS) information configured to be used to check the frame for an error.

In the meantime, as shown in FIG. 2, in the conventional communication frame structure, when a transmission error occurs in a part of a payload while data is transmitted between a transmitter and a receiver on a wireless communication network for implantable medical devices, the transmission of the entire frame is requested and the entire frame is received. In this case, frame-based transmission is performed, and therefore the amounts of data to be transmitted and received increase, thereby increasing the loss of power. As a result, there arises the problem of the life spans of the batteries of implantable medical device rapidly decreasing.

Furthermore, in order to improve frame transmission efficiency, that is, communication efficiency, the structure of a frame capable of supporting a frame flow control function is required.

### SUMMARY OF THE INVENTION

Accordingly, the present invention has been made keeping in mind the above problems occurring in the prior art, and an object of the present invention is to provide a method of forming communication frames on a wireless communication network for implantable medical devices, in which, even when a transmission error occurs in a data block of the payload of a frame while data is being transmitted between a transmitter and a receiver on a wireless communication network for implantable medical devices, the transmission of only the corresponding data block of the payload can be requested and only the corresponding data block can be received, thereby reducing the amounts of data to be transmitted and received and the loss of power.

Another object of the present invention is to provide a method of forming communication frames on a wireless communication network for implantable medical devices, in which the structure of a frame has a flow control function during communication between a transmitter and a receiver, thereby improving communication efficiency.

In order to accomplish the above object, the present invention provides a method of forming communication frames capable of supporting improved communication efficiency, which are used on a wireless communication network for implantable medical devices and which each include a PHY header, a MAC header and a payload, the method including:
forming the PHY header so that the PHY header includes information configured to support synchronization with a reception unit, information indicative of a start of the frame, and information indicative of an overall size of the frame;
forming the MAC header so that the MAC header includes information indicative of a type of frame, information configured to be used to check for a sequence of the frame, information configured to be used to control a flow of the frame, flag information configured to identify a plurality of same-size data blocks of the payload, information indicative of a size of the data block, source and destination information configured to support a connection between a source and a destination, and information configured to be used to check the header of the frame for an error and correct the error; and
forming the payload so that the payload is divided into a plurality of same-size data blocks to represent information about data to be transmitted, each of the data blocks including information configured to be used to check for presence of an error and correct the error.

The MAC header may further include information indicative of the use of security.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a diagram showing an example of a conventional MICS;

FIG. 2 is a diagram showing an example of the structure of a conventional communication frame;

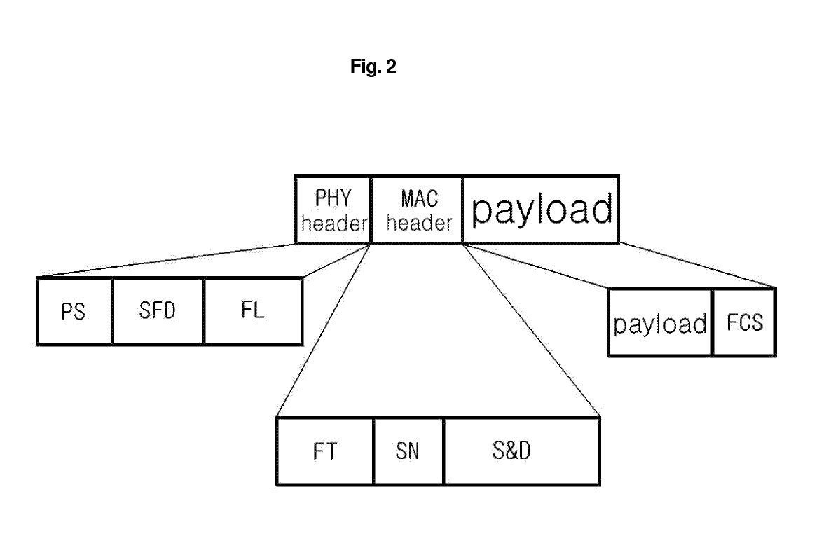

FIG. 3 is a diagram showing the structure of a communication frame that is used in a wireless communication network for implantable medical devices according to an embodiment of the present invention;

FIG. 4 is a diagram showing a frame retransmission mechanism according to an embodiment of the present invention; and

FIG. 5 is a diagram showing frame transmission flow control according to an embodiment of the present invention.

### DESCRIPTION OF THE PREFERRED EMBODIMENTS

Reference now should be made to the drawings, in which the same reference numerals are used throughout the different drawings to designate the same or similar components.

The present invention will be described with reference to the accompanying drawings in detail. In the following description of the present invention, if detailed descriptions of related known functions or configurations or descriptions apparent to those skilled in the art make the gist of the present invention unnecessarily vague, they will be omitted.

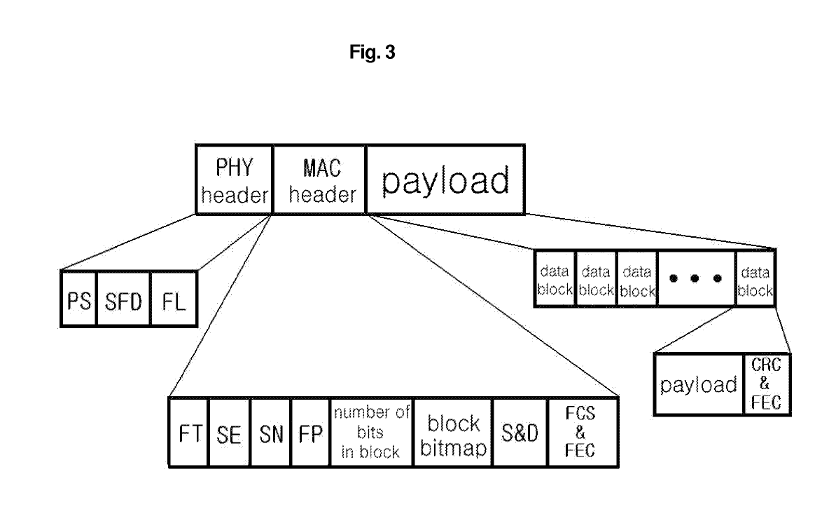

FIG. 3 is a diagram showing the structure of a communication frame that is used in a wireless communication network for implantable medical devices according to an embodiment of the present invention. A communication frame that is used in a wireless communication network for implantable medical devices includes a PHY header, a MAC header, and a payload.

The PHY header includes a Preamble Sequence (PS) information field configured to support synchronization with a reception unit, a Start of Frame Delimiter (SFD) information field indicative of the start of the frame, and a Frame Length (FL) information field indicative of the overall size of the frame.

The MAC header includes a Frame Type (FT) information field indicative of the type of frame, a Sequence Number (SN) information field configured to be used to check for the sequence of the frame, a Frame Pending (FP) information field configured to be used to control the flow of the frame, a block bitmap information field indicative of flag information configured to be used to identify the plurality of data blocks of a payload, that is, information about data to be transmitted, a number-of-bits-in-a-block information field indicative of the size of a data block, a source and destination (S&D) information field configured to support the connection between a source and a destination, and a Frame Check Sequence (FCS) & Forward Error Correct (FEC) information field configured to be used to check the header of the frame for an error and correct the error.

Furthermore, the payload is representative of information about data to be transmitted, and is divided into a plurality of same-size data blocks. Each of the plurality of data blocks includes a Cyclic Redundancy Check (CRC) & Forward Error Correct (FEC) information field configured to be used to check the frame for an error and correct the error.

Here, the MAC header may further include a Security Enabled (SE) information field indicative of the use of security between a source and a destination during communication.

Furthermore, the types of frames which are used in the FT information field of the MAC header include a data frame, an ack frame, a beacon frame, and a command frame.

Furthermore, in an embodiment, the S&D information field of the MAC header includes a Body Area Network ID (BAN ID) information field indicative of a BAN ID, that is, a unique ID information on a single network constructed by the corresponding implantable medical device, and a local transceiver ID information field indicative of a local transceiver ID, that is, a unique ID information on the different networks of a variety of networks constructed by implantable medical devices.

In this case, in the structure of the frame according to the present invention, the information fields that constitute each of the PHY header, the MAC header and the payload are not characterized in terms of the sequence, and each of the PHY header, the MAC header and the payload may further include an information field configured to support additional functionality in conformity with the requirements of a corresponding communication standard.

Furthermore, the block bitmap information field of the MAC header is representative of the flag of each of a plurality of data blocks that constitute the payload. For example, when the size of the block bitmap information field of the MAC header is given as 4 bytes, a maximum of 32 blocks can be represented using 32 bits. In greater detail, when the size of the block bitmap information field is given as 4 bytes and a plurality of data block is divided into eight blocks, the expression “11111111 00000000 00000000 00000000” may be given (here, the spacing between bits is used to help better understanding using a byte-based expression). A recipient can be aware that the number of data blocks to be received is eight based on the block bitmap information field.

Furthermore, the size of each data block (that is, the number of bits) is represented using the number-of-bits-in-a-block information field of the MAC header. The number-of-bits-in-a-block information field may vary depending on the size of data to be transmitted within the set size of the payload.

Furthermore, since each of the plurality of data blocks of the payload includes a CRC & FEC information field that is used to check for the presence of an error and correct the error, a destination can determine a data block of the plurality of data block having the error and then request the transmitter to retransmit only the corresponding data block.

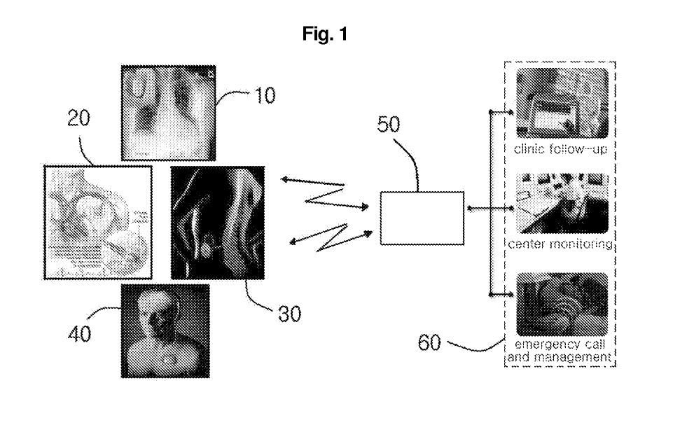

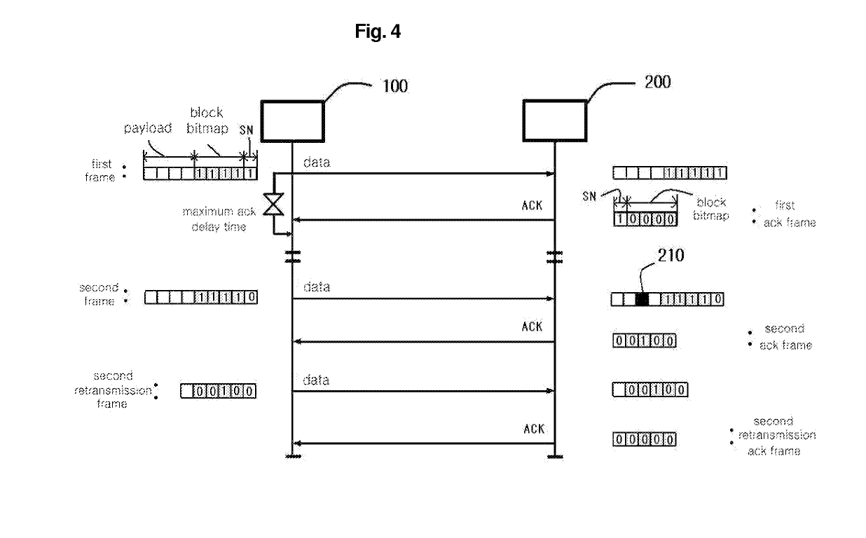

FIG. 4 is a diagram showing a frame retransmission mechanism according to an embodiment of the present invention. This drawing illustrates a frame retransmission mechanism in which an implantable medical device (hereinafter referred to as the “implantable device”) 200 requests a coordinator 100 to retransmit only a data block which belongs to a plurality of data blocks and in which an error was detected and then receives only the corresponding data block. However, in FIG. 4, in order to help to understand the frame retransmission mechanism, the structure of a frame is shown by illustrating only the SN information field (represented by 1 bit) and block bitmap information field (represented by 4 bits) of the MAC header and the plurality of data blocks of the payload, which are selected from the structure of the frame to be transmitted. The remaining information fields are omitted in the drawing. Here, the coordinator is a device which performs network management on a wireless communication network for implantable medical devices, and may also function as a relay connecting the implantable devices 10, 20, 30 and 40 to the external management apparatus 60, as previously described in conjunction with FIG. 1.

As shown in FIG. 4, the coordinator 100 transmits a first frame, in which the value of the information field is “1,” the value of the block bitmap information field is “1111,” and four data blocks are provided by the block bitmap information field, to the implantable device 200 as a data frame. The implantable device 200 which has received the first frame checks the received first frame for an error and corrects the error, and, if there is no error, forms a first ack frame, in which the value of the SN information field is “1” and the value of the block bitmap information field is “0000,” as an ack frame, and transmits it to the coordinator 100. That is, the first ack frame notifies the coordinator 100 that as regard to the first frame in which the value of the SN information field is “1,” there is no block bitmap information field to be requested. In this case, the maximum ack delay time is set between the coordinator 100 and the implantable device 200 in advance. Accordingly, when the maximum ack delay time has passed without receiving a first ack frame after the transmission of the first frame, the coordinator 100 considers that the implantable device 200 has not received the first frame, and retransmits the first frame.

Thereafter, the coordinator 100 transmits a second frame, in which the value of the SN information field is “0,” the value of the block bitmap information field is “1111” and four data blocks are provide by the block bitmap information field, to the implantable device 200. The implantable device 200 which has received the second frame checks the received second frame for an error and corrects the error, and, if the error is detected in a second data block, forms a second ack frame, in which the value of the SN information field is “0” and the value of the block bitmap information field is “0100,” as an ack frame and transmits the second ack frame to the coordinator 100. That is, the second ack frame indicates that in regard to the second frame in which the value of the SN information field is “0,” the retransmission of only the second data block is requested. Accordingly, the coordinator 100 which has received the second ack frame retransmits a second retransmission frame, in which the value of the SN information field is “0,” the value of the block bitmap information field is “0100” (however, in FIG. 4, “0010” is used when the transmission direction of data is represented, and indicates that a value is present only in the second data block) and one data block is provided by the block bitmap information field, to the implantable device 200. Here, the second retransmission frame indicates that with regard to the second frame in which the value of the SN information field is “0,” only the second data block will be transmitted. The implantable device 200 which has received the second retransmission frame checks the second retransmission frame for an error and corrects the error, and, if there is no error, transmits a second retransmission ack frame, in which the value of the SN information field is “0” and the value of the block bitmap information field is “0000,” as an ack frame and retransmits the second retransmission ack frame to the coordinator 100. That is, the second retransmission ack frame notifies the coordinator 100 that with regard to the second retransmission frame the value of the SN information field is “0,” there is no block bitmap information field to be requested. Furthermore, although not shown, it is apparent that the maximum ack delay time is also set after the transmission of the second frame and the second retransmission frame.

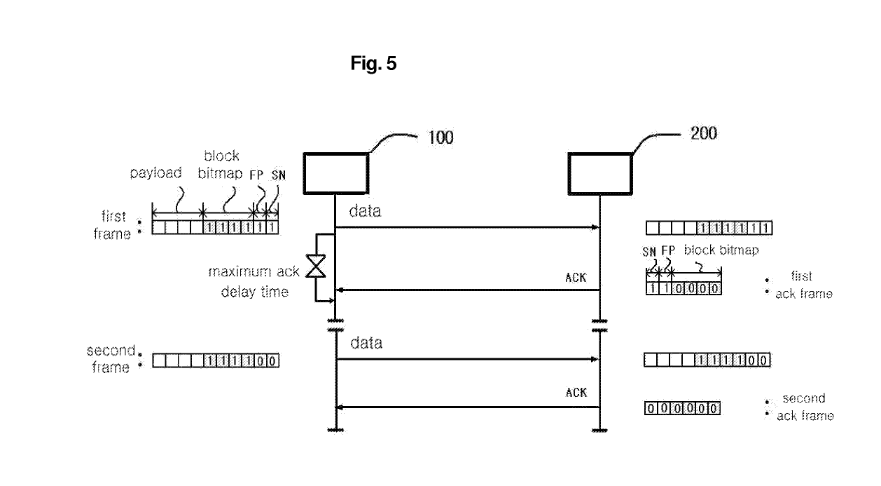

FIG. 5 is a diagram showing frame transmission flow control according to an embodiment of the present invention. This drawing illustrates flow control between the coordinator 100 and the implantable device 200, that is, frame transmission flow control related to whether there is a frame to be further transmitted by the FP information field of the MAC header, and whether a frame can be further received. However, in FIG. 5, in order to help to understand frame transmission flow control, the structure of a frame is shown by illustrating only the SN information field (represented by 1 bit), FP information field (represented by 1 bit) and block bitmap information field (represented by 4 bits) of the MAC header and the plurality of data blocks of the payload, which are selected from the structure of the frame to be transmitted. The remaining information fields are omitted in the drawing.

As shown in the drawing, the coordinator 100 transmits a first frame, in which the value of the SN information field is “1,” the value of the FP information field is “1,” the value of the bitmap information field is “1111” and four data blocks are provided by the block bitmap information field, to the implantable device 200. Here, the fact that the value of the FP information field is “1” indicates that the transmission of an additional second frame remains. The implantable device 200 which has received the first frame transmits a first ack frame, in which the value of the SN information field is “1,” the value of the FP information field is “1” and the value of the block bitmap information field is “0000,” to the coordinator 100 as an ack frame. That is, the first ack frame indicates that with regard to the first frame in which the value of the SN information field is “1,” there is no block bitmap information field to be requested and a second frame will be further received.

Thereafter, the coordinator 100 transmits the second frame, in which the value of the SN information field is “0,” the value of the FP information field is “0,” the value of the block bitmap information field is “1111” and four data blocks are provided by the block bitmap information field, to the implantable device 200. Here, the fact that the value of the FP information field is “0” indicates that there is no transmission of an additional frame. The implantable device 200 which has received the second frame forms a second ack frame, in which the value of the SN information field is “0,” the value of the FP information field is “0,” and the value of the block bitmap information field is “0000,” as an ack frame, and transmits the second ack frame to the coordinator 100. That is, the second ack frame indicates that sleep mode will be entered because with regard to the second frame in which the value of the SN information field is “0,” there is no block bitmap information field to be requested, and there is no transmission of an additional frame. In the same manner, although not shown in the drawing, the coordinator which has received an ack frame in which the value of the FP information field is “0” stops transmission when the implantable device which has received the frame transmits the ack frame in the case where the implantable device does not need to receive data or cannot receive data.

Meanwhile, although the present invention relates to the structure of the communication frame that is used between the coordinator 100 and the implantable device 200 on a wireless communication network for implantable medical devices, it is apparent that the communication between the coordinator 50 and the external management apparatus 60 should be performed using the structure of a frame in conformity with a corresponding communication standard, as shown in FIG. 1.

According to the above-described present invention, even when a transmission error occurs in a data block of the payload of a frame while data is being transmitted between a transmitter and a receiver on a wireless communication network for implantable medical devices, the transmission of only the corresponding data block of the payload can be requested and only the corresponding data block can be received, thereby reducing the amounts of data to be transmitted and received and the loss of power. Furthermore, the structure of a frame has a flow control function, thereby improving communication efficiency during communication between a transmitter and a receiver.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A method of forming communication frames capable of supporting improved communication efficiency, which are used on a wireless communication network for implantable medical devices and which each include a PHY header, a MAC header and a payload, the method comprising:
forming the PHY header so that the PHY header includes information configured to support synchronization with a reception unit, information indicative of a start of the frame, and information indicative of an overall size of the frame;
forming the MAC header so that the MAC header includes information indicative of a type of frame, information configured to be used to check for a sequence of the frame, information configured to be used to control a flow of the frame, flag information configured to identify a plurality of same-size data blocks of the payload, information indicative of a size of the data block, source and destination information configured to support a connection between a source and a destination, and information configured to be used to check the header of the frame for an error and correct the error; and
forming the payload so that the payload is divided into a plurality of same-size data blocks to represent information about data to be transmitted, each of the data blocks including information configured to be used to check for presence of an error and correct the error.

2. The method as set forth in claim 1, wherein the MAC header further includes information indicative of use of security.
